(19) United States
(12) Patent Application Publication
(10) Pub. No.: US 2002/0012329 A1
(43) Pub. Date: Jan. 31, 2002

(54) Communications apparatus interface and method for discovery of remote devices

(76) Inventors: Timothy Atkinson, Ottawa (CA); Andrew Leszczynski, Nepean (CA)

Correspondence Address: Zucotto Wireless, c/o Mark Wardas, Ste. 400, 4225 Executive Square, La Jolla, CA, 92037, US

(21) Appl. No.: 09/849,648

(22) Filed: May 4, 2001

Related U.S. Application Data
(60) Provisional application No. 60/224,701, filed on Aug. 11, 2000.
(60) Provisional application No. 60/227,878, filed on Aug. 25, 2000.
(60) Provisional application No. 60/243,654, filed on Oct. 26, 2000.
(60) Provisional application No. 60/250,928, filed on Dec. 1, 2000.
(60) Provisional application No. 60/254,595, filed on Dec. 11, 2000.
(60) Provisional application No. 60/208,967, filed on Jun. 2, 2000.
(60) Provisional application No. 60/220,047, filed on Jul. 21, 2000.
(60) Provisional application No. 60/239,320, filed on Oct. 10, 2000.
(60) Provisional application No. 60/267,555, filed on Feb. 9, 2001.
(60) Provisional application No. 60/271,607, filed on Feb. 26, 2001.

(51) Int. Cl. H04Q 7/00

(52) U.S. Cl. 370/330; 370/282

(57) ABSTRACT

On the fly execution of software instructions and/or operations on information transferred between wireless and/or wired devices is provided.

### RELATED APPLICATIONS

This Application is related to and claims priority from the following commonly assigned Applications: Provisional Application Ser. No. 60/224,701, filed Aug. 11, 2000; Provisional Application 60/227,878, filed Aug. 25, 2000; Provisional Application 60/243,654, Oct. 26, 2000; Provisional Application 60/250,928, filed Dec. 1, 2000; Provisional Application 60/254,595, filed Dec. 11, 2000; Provisional Application Ser. No. 60/208,967, filed Jun. 2, 2000; Provisional Application Ser. No. 60/220,047, filed Jul. 21, 2000; Provisional Application 60/239,320, filed Oct. 10, 2000; Provisional Application Ser. No. 60/267,555, filed Feb. 9, 2001; and Provisional Application 60/271,607, filed Feb. 26, 2001.

### FIELD OF THE INVENTION

This invention relates to wireless communications between devices and more particularly, to Java™ or Java-like technology based communications between baseband technology enabled devices.

### BACKGROUND

Explosive growth of telecommunications drives demand for ever smaller and less expensive communication devices. The growth of portable wireless communications is particularly relentless, having expanded well beyond the ubiquitous cellular phone used for voice transmission. By now, Internet-enabled cellular telephones, pagers and personal digital assistants (“PDAs”) have become commonplace. The use of hand-held wireless devices in more mature applications continues to grow as well. Such devices include, for example, wireless controllers for car alarms and portable electronic game playing devices.

Wireless communication devices are also beginning to replace short cables. The main objective here is convenience. It is, of course, much easier to install a multi-component system if the individual components need not be connected by cables. And most consumers would likely appreciate a desktop computer system sans the tangle of wires behind it.

In cable-replacement applications, short-range RF communications are soon to become the wireless technology of choice because RF does not require a clear line-of-sight between communicating devices. This feature provides an important advantage over infrared-based technologies. Relative simplicity of installation of RF transceivers often allows use of small networks where permanent line-of-sight transceiver positioning is not feasible. Wired installation is prohibitively expensive because of the labor involved in stringing cables. This is often the case for home computer networks and security systems.

One fast growing short-range RF standard is Bluetooth™, which was initially propounded by Bluetooth Special Interest Group founded by Ericsson, IBM, Intel, Lucent, Microsoft, Motorola, Nokia, and Toshiba. Parts A and B of the standard, pages 15-31 and 33-184, respectively, available as of the writing of this application at www.bluetooth.com/developer/specification/specification.asp. The Bluetooth technology provides an open standard for wireless spread-spectrum communications in the 2.4 GHz unlicensed Industrial-Scientific-Medical (“ISM”) band. It supports both data and voice communications, using synchronous and asynchronous channels. Bluetooth enabled devices use radiated power of 0 dbm (1 mW), generally sufficient for transmissions over a 10 meter range. The power can be boosted to +20 dbm (100 mW), increasing the range to approximately 100 meters.

Bluetooth communications take place among devices grouped in piconets, with each piconet synchronized to a unique pseudo-random frequency-hopping pattern. In the United States, there are a total of seventy-nine unique 1 MHz wide frequency channels between 2.402 and 2.480 GHz of the ISM band. The devices of each piconet move—“hop”—through the pattern of the piconet at the rate of 1600 channels per second. Thus, each channel's time slot lasts 625 μseconds. At the end of one time slot, the devices of the piconet may hop to the next frequency in the pattern.

The Bluetooth technology comprises a packetized protocol with ad hoc device discovery and connections. Each packet is transmitted in at least one time slot, at a single frequency. The transmission of a packet can extend up to a total of five 625 μsecond time slots, during which period the frequency of the piconet does not change.

Each piconet has one master device and one or more slave devices. Devices may belong to more than one piconet at a time. Multi-piconet devices act as bridges, connecting different piconets into larger scatternets. Piconets may be dynamic, changing as devices move in-and out-of-range.

Although the symbol rate used is 1 Mbit/s, the rate available for information exchange is limited by overhead to about 780 kb/s. This translates into a maximum asymmetric rate of 723 kb/s (with 58 kb/s in the return direction, including acknowledgements), or a 434 kb/s symmetric rate.

Thirteen different Bluetooth packet types have been defined to date. Packets of each type include three segments: access code, and packet header and payload. Payload is the actual information being transmitted. Access codes are used for timing and functions related to establishing connections between devices, such as paging and inquiry. Header is used for addressing, acknowledgements, flow control, and packet sequencing.

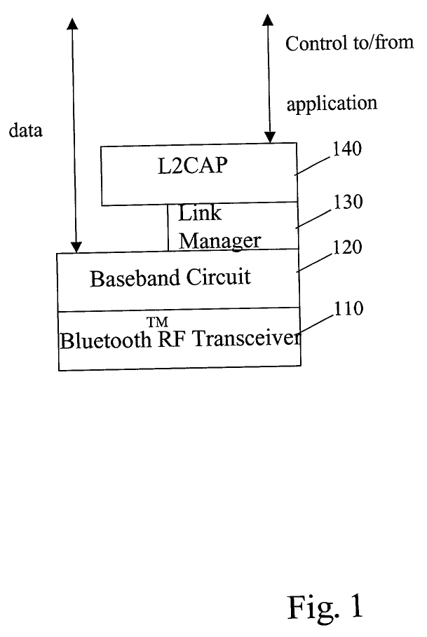

Referring to FIG. 1, a simplified illustration of one embodiment of a Bluetooth architecture is seen. The architecture includes functional hardware blocks, including a RF transceiver/radio 110, a baseband circuit 120, and a link manager 130. RF transceiver 110 generates data-modulated RF signals, and receives and demodulates such signals. In one embodiment, the RF transceiver is a 2.4 GHz frequency-hopping system with 1 MHz-spaced channels and 0 dbm typical transmitted power. It uses GFSK modulation. The layers above the link manager 130, e.g., logical link control and adaptation protocol (“L2CAP”), may be host-implemented.

Baseband circuit 120 comprises a physical layer that lies above the RF transceiver/radio 110 layer. The baseband circuit 120 also manages physical communication channels, links, and packets, as well as performs inquiry and paging functions. More generally, the baseband 120 of a wireless communications system comprises a functional block that converts host data intended for transmission into transmission protocol-compliant coded form, and converts received signals into a form that can be understood by a host application. In one embodiment, a host application may be in or on a wireless telephone or PDA. The baseband circuit 120 may check received data for accuracy, perform de-packetization, reassemble, and uncompress the data. Conversely, the baseband circuit 120 may accept the data for transmission from a host application, convert it into a proper format (e.g., from audio to digital data), compress it, assemble and packetize it, assign identifiers to the data, and encode it using an error correction code.

In the embodiment described above, the link manager 130 searches for other Bluetooth devices within its communication range, establishes links, and handles authentication, configuration, and related protocol functions. It also controls the baseband's state machine.

Many consumer devices may, thus, be equipped with baseband communications circuits in the future. One known implementation allows Bluetooth devices to communicate with each other using PCMCIA Bluetooth hardware cards such as those offered by Digianswer and Motorola Corporations and a software application “Bluetooth Neighborhood.” Unfortunately, shortcomings of the aforementioned implementation include platform dependency (i.e., Win32), device discovery results cannot be customized, difficult program management of a list of active devices in range, and difficulty in providing dynamic notification of devices leaving or coming into range. In addition this solution is not portable to hand held devices such as cell phones or personal digital assistants that do not have the resources required to run a Win32 operating system.

Typical embedded Java technology solutions use a Java virtual machine (JVM) layered on top of a real time operating system (RTOS), which in turn is incorporated to operate on top of a general-purpose microprocessor or micro-controller. Because there exist multiple levels of hierarchy in such solutions, peripheral drivers, which are typically written in C, are very difficult to integrate for use with hardware devices, the RTOS, and the JVM, which is not to mention the 100's of pages of manuals and three different vendors: application drivers, RTOS, and microprocessors; that have to be dealt with when implementing such a solution. System features that are not handled, or not handled well by typical JVM implementations include, memory management, file systems, and the interface between applications and the outside world of peripherals, interrupts, user interaction, and application programming interfaces (APIs). In addition, a JVM on a RTOS solution is typically very slow (a Java NOP instruction can take up to 17 processor machine cycles to execute for example) so either response time is unacceptably slow to the user or a very high speed processor must be used which in turn will consume unacceptably large amounts of power, which may be a key concern in battery powered devices. Large amounts of memory are also required for both a JVM and a RTOS.

In Java capable processor based devices, wireless data is provided to applications running on a Java native processor. Despite the fact Java is destined to be the defacto programming language for mobile communications devices, the Java industry has yet to provide wireless Java communication protocol stacks suitable for interfacing with Java processors, applications, applets and Midlets directly, for instance NTT DoCoMo Inc.'s I-mode specification lacks such functionality. Existing optimizations may serve to speed up the execution of the applications running on the processor, but do little to improve the applications' access to data or information communicated to the device via wireless means.

The embodiments described in the description that follows address these as well as other limitations.

### SUMMARY OF THE INVENTION

In various embodiments, a device, method, means, and computer readable medium are provided for dynamic on the fly operation on or execution of data and/or software instructions transferred between wireless and/or wired devices. In one embodiment, a protocol stack may be used to enable personal networking between a variety of systems and/or devices that utilize Java or Java-like languages, including, but not limited to, systems and devices that operate with WIN 32, Macintosh OS, UNIX, and real-time operating systems. The systems and/or devices may implement Java or Java-like languages and technology in software, hardware, or both. With the embodiments described herein, Application developers, system integrators, and OEMs may dramatically reduce the time to market required to implement wireless connectivity for use with applications and devices.

In one embodiment, a communications protocol stack may comprise software instructions that may be grouped as Java or Java-like modules/layers/profiles. Functionality of the software instructions may be easily changed and/or extended without a necessity for compiling or recompiling of any code. The functionality of the Java or Java-like communications protocol stack may be portable to devices supporting a Java or Java-like virtual machine. In one embodiment, the protocol stack may be transferable between devices comprising variants of Java including the Java 2 Platform, Standard Edition (J2SE™) designed for servers and desktop computers, and the Java 2 Platform, Micro Edition (J2ME™) designed for small devices.

Information received from other devices may be dynamically linked to the protocol stack and dynamically executed directly at run-time on the fly. The information may reside on first device in executable binary form, may be compressed and transferred to a second device, and may be executed on the second device after decompression to the same executable binary form that it existed in on the first device without the need for compiling or recompiling the information.

Protocol layers and profiles may be added or removed as needed, even while the protocol stack is running. Device users can select the protocol layers and profiles to initialize, and can download additional protocols and profiles across a network, adding them to the stack as they are needed. Seldom-used layers may be discarded after an application has finished using them, freeing up valuable memory in devices that are memory resource-constrained, for example, handheld wireless devices. Dynamic linking and execution may be done independent of a particular operating system or platform a particular device is operating under or on.

In one embodiment, a method of modifying a wireless protocol stack on a first device is provided, the protocol stack comprising a plurality of protocol layers, the protocol layers comprising one or more existing software components, the method comprising the steps of: providing the protocol stack in a run-time system on the first device; downloading at least one updated software component to the first device; loading the at least one software component into the run-time system; and replacing one or more of the exiting software components with the at least one updated software component to update the protocol stack on the fly while the protocol stack is running in run-time. The existing software components and the at least one updated software components may comprise platform independent software instructions. The platform independent software instructions may comprise Java™ software instructions. The at least one updated software component may comprise an update to at least one of the protocol layers. The at least one updated software component may comprise an update to all the protocol layers.

In one embodiment, a wireless device may comprise: a baseband circuit, the baseband circuit receiving functionality as transmitted in object form by a second device; and a platform independent protocol stack, the platform independent protocol stack transferring the functionality from the baseband circuit such that the wireless device may utilize the functionality on the fly during run-time and in the object form transmitted by the second device.

In one embodiment, a device operating with a first operating environment, the first device may comprise: a memory; a protocol stack, the protocol stack residing in the memory, the protocol stack comprising executable Java-like functionality, the executable Java-like functionality modifiable on the fly; and execution means for executing the executable Java-like functionality. The first device may further comprise a wireless baseband circuit, the baseband circuit receiving the executable Java-like functionality and providing the executable Java-like functionality to the protocol stack. The executable Java-like functionality may be selected from a group consisting of software instruction, software module, software layer, API, object code file, software interface to hardware, class file, class file archive, security manager, file transfer protocol, object exchange protocol (OBEX), TCP/IP stack, synchronization profile, object push profile, dial-up networking profile, bug fix, code patch, and LAN access profile functionality. The executable Java-like functionality may be received from a second device operating under a second operating environment, the second operating environment differing from the first operating environment. The protocol stack may comprise a Bluetooth™ compatible protocol stack. The first device may comprise a cellular phone. The first device may be selected from a group consisting of: a personal digital assistant, wireless base station, network access point, gaming device, music player/recorder, remote control, industrial automation control device, personal organizer, wireless audio device, and sensor interface. The baseband circuit may comprise a Bluetooth™ baseband circuit. The first operating environment may comprise a virtual machine, the second operating environment selected from the group consisting of a Windows operating environment, a Unix-based operating environment, a Macintosh operating environment, a Linux operating environment, a DOS operating environment, a PalmOS operating environment, a virtual machine environment, and a Real Time Operating System operating environment. The first operating environment may comprise a Windows operating environment, the second operating environment selected from the group consisting of a Unix-based operating environment, a Macintosh operating environment, a Linux operating environment, a DOS operating environment, a PalmOS operating environment, virtual machine and support software operating environment, and a Real Time Operating System operating environment. The execution means may execute the executable Java-like functionality as micro-instructions.

In one embodiment, a first device may operate under a first operating environment, the first device comprising: means for transferring a protocol stack to the first device from a second device operating under a second operating environment; and a baseband circuit, the baseband circuit interacting with the protocol stack to transfer information between the first device and the second device. The first operating environment may differ from the second operating environment.

In one embodiment, a first device may operate under a first operating environment for communicating with a second device operating under a second operating environment, the first device comprising: means for transferring software instructions from the second device to the first device; and means for executing the software instructions dynamically at run-time. The means for transferring may comprise a communications protocol stack. The means for executing the software instructions may comprise an application layer program. The protocol stack may comprise semi-compiled/interpreted instructions. The software instructions may comprise byte-codes. The first operating environment may differ from the second operating environment. The first operating environment may comprise a virtual machine and software support layer, the software instructions originating from a second operating environment selected from the group consisting of: a Windows operating environment, a Unix operating environment, a Macintosh operating environment, a Linux operating environment, a DOS operating environment, a PalmOS operating environment, and a Real Time Operating System operating environment. The first device may comprise a wireless device. The software instructions may comprise Java™ byte-codes. The software instructions may comprise a protocol stack.

In one embodiment, a method of communicating between a first wireless device operating under a first operating environment and a second wireless device operating under a second operating environment may comprise the steps of: downloading platform independent software instructions in executable form from the second device to the first device; and executing the instructions on the fly. The software instructions may comprise a protocol stack. The step of downloading software instructions may comprise downloading over a wireless medium. The software instructions may comprise Java-like software instructions. The protocol stack may comprise a platform independent protocol stack. The first operating environment may differ from the second operating environment.

In one embodiment, a wireless device operating with a first operating environment for communicating with other devices operating with a second operating environment may comprise: a storage location; means for downloading functionality existing on the other devices to the storage location; a processor; and an application program, the application program running on the processor; the application program utilizing the functionality on the fly at run-time. The functionality may comprise a protocol stack. The functionality may comprise two or more protocol stacks. The means for downloading may comprise a communications protocol selected from the group consisting of: Bluetooth™, GSM, 802.11, 802.11b, 802.15, WiFi, IrDA, HomeRF, 3GPP, 3GPP2, CDMA, HDR, and TDMA, UMTS, GPRS, I-mode, IMT-2000, iDEN, Edge, Ethernet, HomePNA, serial, USB, parallel, Firewire, and SCSI protocols. The device may further comprise a baseband circuit, the baseband circuit communicating with the other devices in cooperation with the protocol stack. The means for downloading functionality may comprise a cellular phone communications protocol, the protocol stack being downloaded utilizing the cellular phone communications protocol. The cellular phone communications protocol may be selected from a group consisting of TDMA, CDMA, GPRS, GSM, EDGE, UMTS, I-mode, IMT-2000, iDEN, and 3GPP protocols. The means for downloading functionality may comprise a communications protocol selected from a group consisting of Bluetooth™, IEEE 802.11, 802.11b WiFi, IEEE 802.15, IrDA, and HomeRF protocols. The functionality may be selected from a group consisting of Java™ byte-code, Java-like software instruction, profile, software module, software layer, API, object code file, class file, class file archive, application data, bug fix, patch, and software interface to hardware functionality. The first operating environment may comprise a virtual machine, the functionality originating from a second operating environment selected from a selected from the group consisting of: a Windows operating environment, a Unix operating environment, a Macintosh operating environment, a Linux operating environment, a DOS operating environment, a PalmOS operating environment, a virtual machine operating environment, and a Real Time Operating System operating environment.

In one embodiment, a wireless device operating under a first operating environment may comprise: a processor; a baseband circuit, the baseband circuit receiving software instructions stored on a second device; and a platform independent protocol stack for transferring software instructions from the baseband to an application program running on the processor, the application program executing the software instructions in the form stored on the second device.

In one embodiment, a computer readable medium may comprise instructions for transferring executable functionality from a wireless baseband, including instructions for converting the executable functionality according to a communications and providing the converted executable functionality directly to the at least one application program at run-time. The executable functionality may be selected from a group consisting of Java™ Byte-code, Java-like software instruction, profile, software module, software layer, API, object code file, class file, class file archive, application data, bug fix, patch, and software interface to hardware functionality. The at least one application program may comprise at least one platform independent protocol stack. The at least one platform independent protocol stack may comprise at least two separate platform independent Java™ based protocol stacks running on a single virtual machine environment. The executable functionality may be received by the baseband circuit in object form, wherein the converted executable functionality is provided to the application program without compilation of the executable functionality.

In one embodiment, a storage device operatively coupled to a processor and a Bluetooth™ baseband may comprise: a platform independent Bluetooth™ protocol stack, the Bluetooth™ protocol stack for operating on Bluetooth1υ packets, the packets being transferred between an application executing on the processor and the Bluetooth™ baseband, the protocol stack comprising Java-like software instructions.

In one embodiment, a wireless device may comprise: a processor; means for storing information; a baseband circuit, the baseband circuit for transmitting and receiving the information; and a wireless protocol stack for transferring the information between the baseband and an application program executing on the processor, the protocol stack residing in or on the means for storing information, the protocol stack comprising Java™ software instructions.

In one embodiment, a device may comprise: a processor; means for storing information; a communication circuit, the communication circuit transmitting and receiving the information as binary information; and a platform-independent communication protocol stack, the platform-independent communication protocol stack transferring binary information between the communication circuit and an application program executing on the processor, the protocol stack residing in or on the means for storing information, the protocol stack comprising a plurality of executable software layers, each layer providing differing functionality, wherein one or more of the layers are dynamically configurable on the fly at -time. The communication circuit may comprise a baseband. The baseband may be selected from the group comprising: Bluetooth, IEEE 802.11, 802.11b, WiFi, GSM, IEEE 802.15, IrDA, 3GPP, 3GPP2, CDMA, HDR, UMTS, GPRS, I-Mode, IMT-2000, iDEN, EDGE, or TDMA basebands. The communication circuit may be selected from the group comprising: Ethernet, HomePNA, HomePlug, serial, USB, parallel, Firewire, and SCSI communication circuits.

In one embodiment, a method of modifying existing protocol layers of an existing protocol stack, the protocol layers comprising one or more existing software components, may comprise the steps of: loading a protocol stack into a run-time environment; downloading at least one new software component; loading the at least one new software component into the run-time environment, wherein the at least one new software component interacts with the existing protocol layers so as to provide additional functionality to the existing protocol at run-time. The existing software components and the new software components may comprise platform independent software instructions. The platform independent software instructions may comprise Java™ or Java-like software instructions. The additional functionality may be selected from the group of functionality comprising: software instructions, software profile, software module, software layer, API, object code file, software interface to hardware, class file, class file archive, security manager, file transfer protocol, object exchange protocol (OBEX), TCP/IP stack, synchronization profile, object push profile, dial-up networking profile, bug fix, patch, and LAN access profile functionality.

In one embodiment, device may comprise: a processor; means for storing software components; at least one application program executing on the processor; at least two communication circuits, the communication circuits transmitting and receiving binary information; and at least two platform-independent communication protocol stacks for transferring software instructions between the at least two communication circuits and the at least one application program executing on the processor, the at least two platform independent protocol stacks comprising software components stored on the means for storing, wherein each of the at least two platform-independent communication protocol stacks comprise instances of the same software components. The software components may comprise or more Classes. The Classes may comprise Java™ or Java-like software instructions. The communications circuits may be selected from the group comprising: Bluetooth, IEEE 802.11, GSM, 802.15, IrDA, 3GPP, 3GPP2, CDMA, or TDMA basebands. The communication circuits may be selected from the group comprising: Ethernet, HomePNA, serial, USB, parallel, Firewire, and SCSI communication circuits. The communications circuits may comprise a first and a second baseband, wherein the binary information comprises a multimedia stream, the first baseband receiving a first portion of the multimedia stream, the second baseband receiving as a second portion of the multimedia stream. The first portion may comprise video information and the second portion may comprise audio information.

In one embodiment, a wireless device may comprise: a processor; multiple baseband circuits, the baseband circuits receiving or transmitting information stored on multiple other devices; and multiple instances of platform independent protocol stacks for transferring information from/to respective baseband circuits. The multiple protocol stacks may be created by multiple instantiations of a common base protocol stack class without requiring explicit duplication of the common base protocol stack class. The base protocol class may comprise Java or Java-like software instructions. The instances of the protocol stacks may further be instantiated with customized functionality for each baseband circuit as required. The specific instances for each baseband circuit and customized functionality may be instantiated when the respective baseband circuit is active to conserve resources on the device.

These as well as other aspects of the invention discussed above may be present in embodiments of the invention in other combinations, separately, or in combination with other aspects and will be better understood with reference to the following drawings, description, and appended claims.

### BRIEF DESCRIPTION OF THE DRAWINGS

Referring to FIG. 1, a simplified illustration of one embodiment of an architecture is seen;

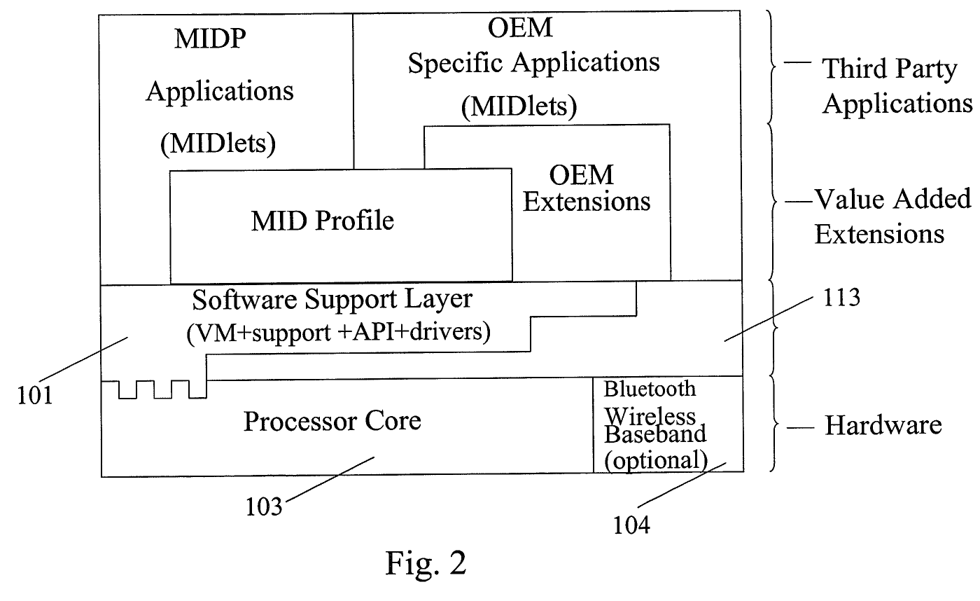

Referring to FIG. 2, a software support layer operating in conjunction with an application written in an interpreted language for execution on a processor is seen;

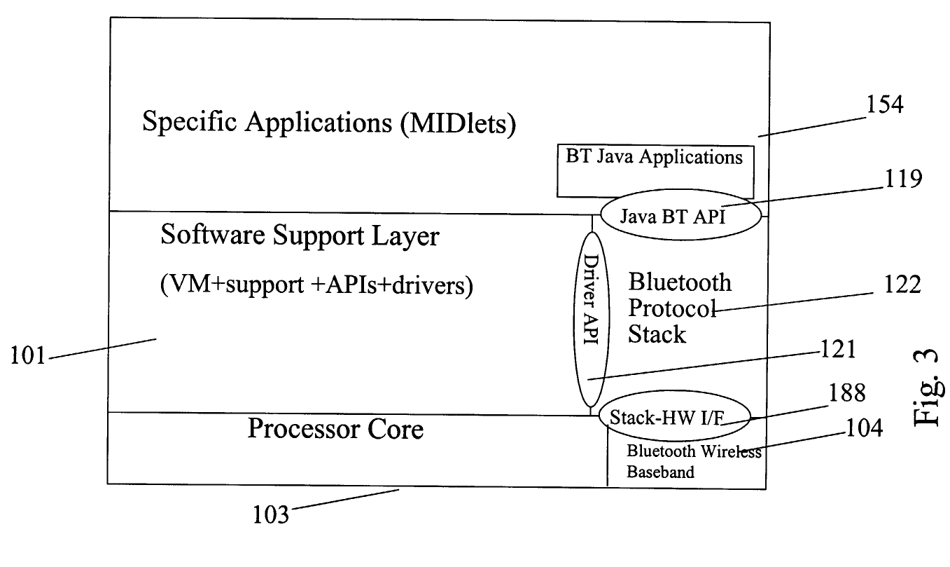

Referring to FIG. 3, an embodiment in which additional functionality may provided to application programs via a software support layer and driver plug-in API's is seen;

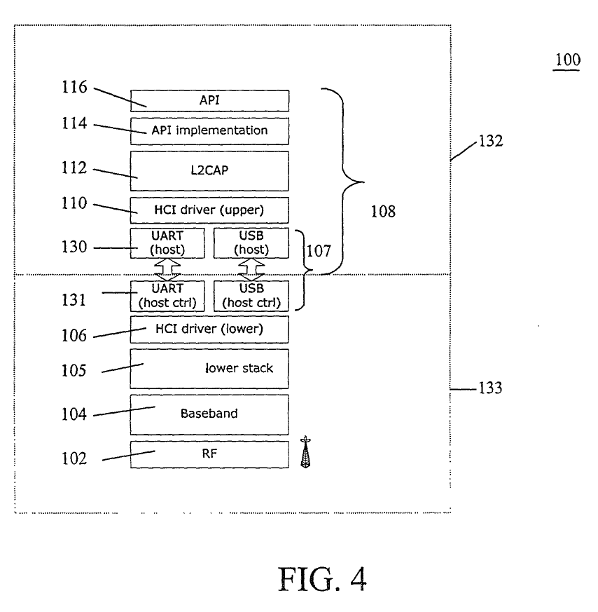

Referring to FIG. 4, a high-level design view of one embodiment for implementing wireless connectivity is seen;

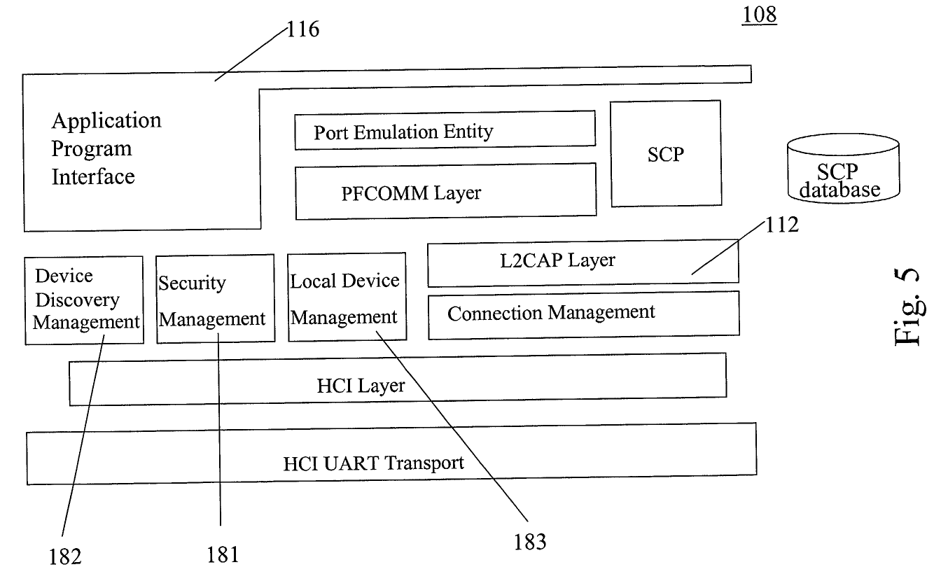

Referring to FIG. 5, an illustration of modules as linked to and within an embodiment of the upper stack is seen;

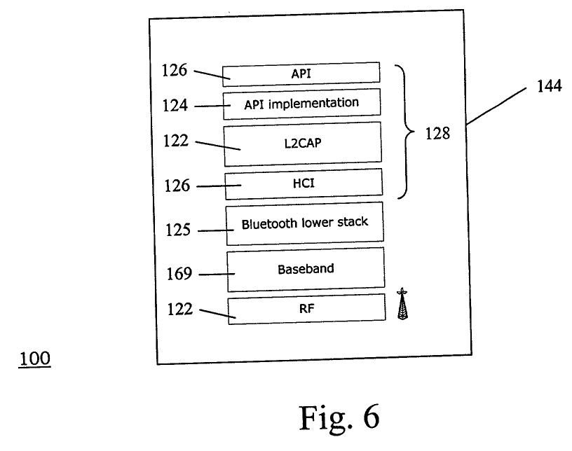

Referring to FIG. 6, an embodiment of a single host configuration is seen;

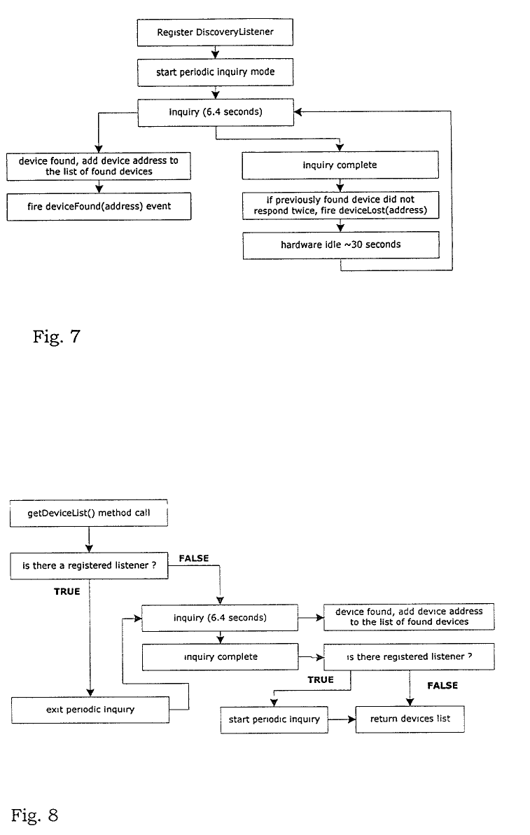

Referring to FIG. 7, a graphical representation of a periodic inquiry process and DiscoveryListener notification mechanism is seen;

Referring to FIG. 8, a graphical representation of a call to the getDeviceList method is seen;

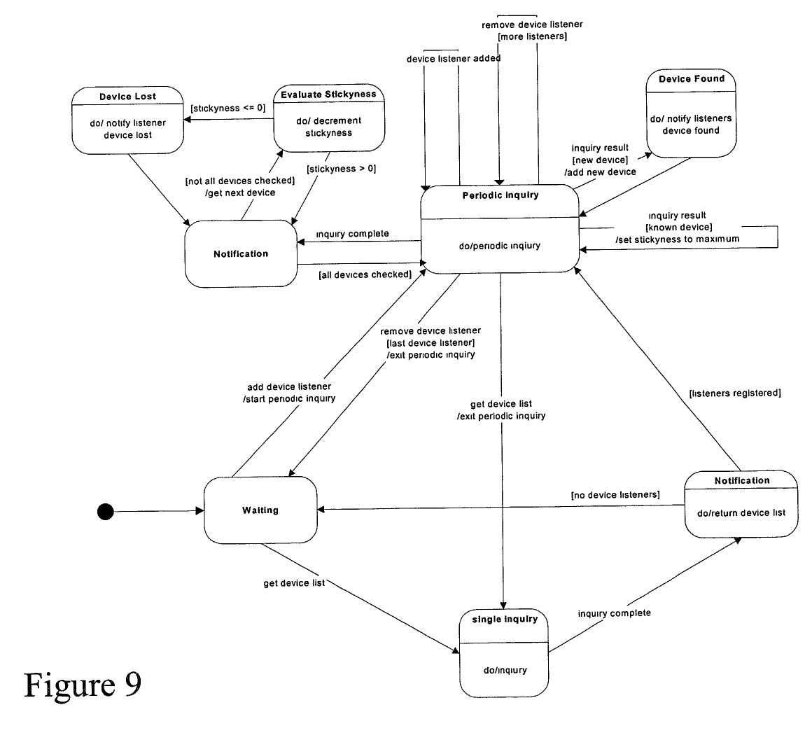

Referring to FIG. 9, a state diagram of an implementation of Discovery Manager is seen;

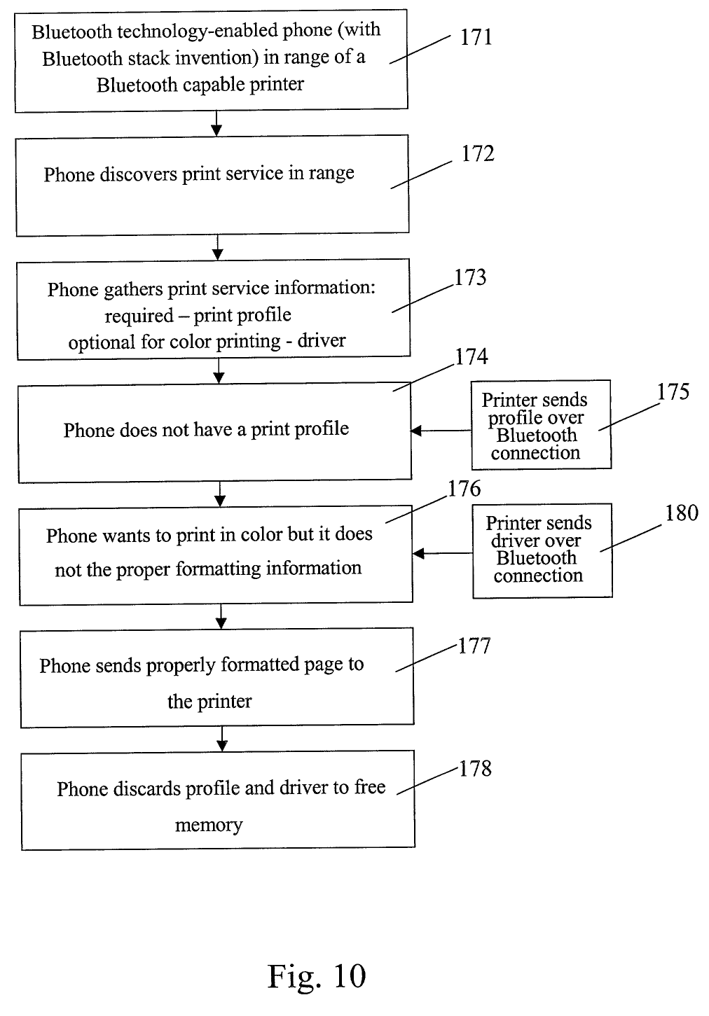

Referring to FIG. 10, a flow diagram for usage of a printer profile is seen; and

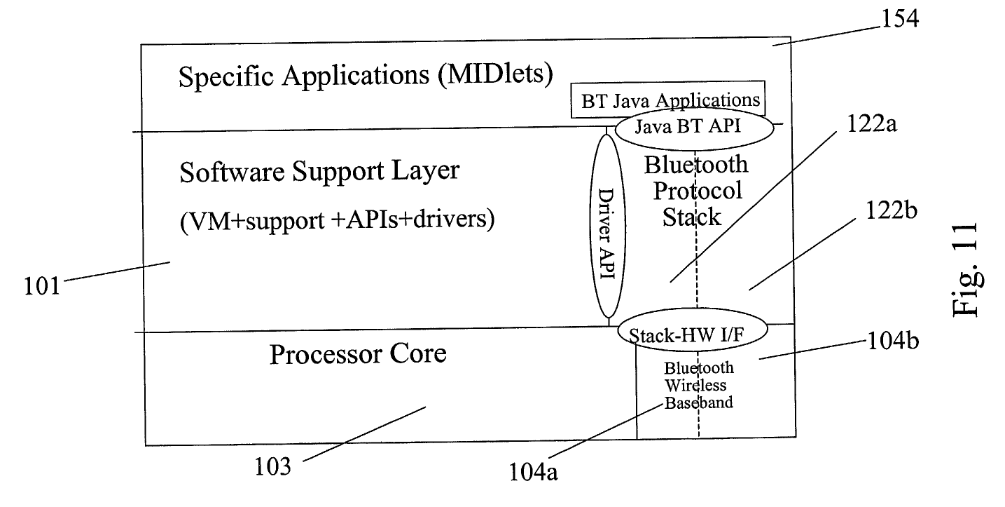

Referring to FIG. 11, an embodiment with two or more protocol stacks is seen.

### DESCRIPTION OF THE INVENTION

Referring now to FIG. 2 and any preceding diagrams as needed, a software support layer 101 operating in conjunction with an application written in a semi-compiled/interpreted or byte compiled language, for example a Java™ or a Java-like language, for execution on and/or by a processor 103 is seen. The present invention may include a software support layer 101 that may be implemented to include, or operate alongside, a virtual machine (VM). In one embodiment, portions of the VM not included as the software support layer may be included as hardware. In one embodiment the VM may comprise a Java™ or Java-like VM embodied to utilize Java 2 Platform, Enterprise Edition (J2EE™), Java 2 Platform, Standard Edition (J2SE™), and/or Java 2 Platform, Micro Edition (J2ME™) programming platforms available from Sun Microsystems. Both J2SE and J2ME provide a standard set of Java programming features, with J2ME providing a subset of the features of J2SE for programming platforms that have limited memory and power resources (i.e., including but not limited to cell phones, PDAs, etc.), while J2EE is targeted at enterprise class server platforms. In one embodiment, software support layer 101 may be implemented to comprise Java™ or Java-like functionality, which may be extended easily through its modular extensions framework. The processor 103 may comprise a CISC machine, with a variable instruction cycle and two levels of programmability/executability, macro-instructions and micro-instructions. Macro-instructions comprise byte-code that processor 103 may execute under control of the software support layer 101 or that may be translated into a sequence of micro-instructions that may be executed directly by hardware comprising the processor 103. In one embodiment, each micro-instruction may be executed in one-clock cycle. In one embodiment, the processor 103 comprises a Java or Java-like native processor. In one embodiment, the software layer 101 may also operate in conjunction with an operating system/environment 113, for example a commercial operating system/environment such as the Windows® OS or Windows® CE, both available from Microsoft Corp., Redmond, Wash. In one embodiment, rather than rely on the functionality of a commercial OS, software layer 101 may provide its own operating system functionality. Features and architecture of the software support layer 101 may include: optimization of certain byte-codes, byte-code replacement techniques, op-code trapping mechanism, hardware specific API support, etc. Software support layer 101 provides the ability to abstract out a particular processor 103 architecture, and if an operating system is also used, the nature of the connectivity between a particular operating system the processor 103 operates under. Such abstraction may be used to provide a consistent view to an application developer desiring to implement an application for use with the present invention. A software support layer is described in commonly assigned U.S. patent application Ser. No. 09/767,038, filed Jan. 22, 2001, and entitled “SOFTWARE SUPPORT LAYER FOR PROCESSORS EXECUTING INTERPRETED LANGUAGE APPLICATIONS”.

Referring now to FIG. 3 and any preceding diagrams as needed, an embodiment in which additional functionality may be provided to application programs via the software support layer 101 and/or driver plug-in API's (application programming interfaces) is seen. In one embodiment, the additional functionality may be provided by and/or may comprise a protocol stack 122. The protocol stack 122 may be used to provide the support layer 101 and application layer programs 154 with wireless connectivity and/or to add to, update, or replace functionality of the protocol stack, the application programs, or the software support layer. The protocol stack 122 may comprise software instructions implemented with Java or Java-like programming language functionality. In one embodiment, the software instructions may comprise byte-codes. The protocol stack 122 may connect to the software support layer 101 through a support layer driver API 121. Protocol stack 122 may also utilize an upper API 119 interface to application programs 154 so as to provide functionality of the protocol stack 122 through wireless network connections provided at the top of the stack to the application programs, and an lower API 188 interface to control the baseband circuit 104 contained within or next to processor 103 provided at the bottom of the stack 122. In one embodiment, application programs may comprise Java or Java-like application programs.

Referring now to FIG. 4 and any preceding diagrams as needed, a high-level design view of one embodiment for implementing wireless connectivity is seen. In one embodiment, a wireless communication protocol may be implemented to enable wireless devices to communicate with each other through a baseband circuit 104, RF module 102, and an associated antenna. In one embodiment, the protocol is compatible with the previously disclosed Bluetooth™ protocol specification. The specification for the Bluetooth protocol is well known to those skilled in the art and includes standardized commands that may be used to perform inquiries to detect other active Bluetooth-enabled devices that are within a communication range. It is understood that even though the Bluetooth™ protocol specification may change over time, such changes are within the scope of the present invention and implementable by those skilled in the art. The RF module 102 enables wireless transfer of data packets and information between devices. The range over which data packets and information may be transferred depends on the power applied by the RF module 102 to the antenna. In one embodiment that communicates with other Bluetooth enabled devices, radiated power of 0 dbm (1 mW) is generally used, which is sufficient for transmissions over a 10 meter range. In one embodiment, the power can be boosted to +20 dbm (100 mW), increasing the range to approximately 100 meters, with such a maximum range identified to be shorter than that of a typical cellular phone maximum communications range.

Although described in a wireless context above, the present invention may operate with a wireless device, a wired device, or a combination thereof. In one embodiment, the present invention may be implemented to operate with or in a fixed device, for example a processor based device, a computer, or the like, architectures of which are many, varied, and well known to those skilled in the art. In one embodiment, the present invention may be implemented to work with or in a portable device, for example, a cellular phone or PDA, architectures of which are many, varied, and well known to those skilled in the art. In one embodiment, the present invention may be included to function with or in an embedded device, architectures of which are many, varied, and well known to those skilled in the art. In one embodiment, the present invention may be implemented as a device or devices comprising part hardware and part software instructions residing on or in a computer readable medium, memory, or other means for storage of information, architectures of which are many, varied, and well known to those skilled in the art.

In one embodiment, the protocol stack 122 may comprise upper 108 and lower 105 protocol stacks, which may be implemented as platform independent Java or Java-like technology-based hardware and software layers/modules compatible with the Bluetooth specification so as to provide a host device notification of other active devices that are in range, to provide notification of other devices that leave range or that become available, to maintain and provide a list of active and in range devices; as well as to provide other platform independent functionalities as described herein. In one embodiment, the lower 105 stack may comprise a link manager and a link controller as required (not shown). In one embodiment, the lower 105 stack software modules may comprise C software instructions and or Java or Java-like software instructions; and the upper 108 stack software modules may comprise Java or Java-like byte-code software instructions.

In one embodiment, get and set methods of a Java class containing device configuration settings may be utilized to set/initialize timeout, inquiry interval/window, and inquiry scan parameters. In one embodiment, the class containing the device configuration settings may be called Device Properties class. In another embodiment, the DeviceManager class may contain the device configuration settings. Initialization of the upper stack 108 may occur during a boot-up (power-on) sequence during which the upper stack is loaded into memory to wait for either user input or events from hardware layers below the lower 105 stack. Base default values may be pre-configured at boot time for use by neophyte programmers or for standard application access. Because the class containing the device configuration settings is extensible, it may be used to allow experienced programmers to modify the base default values or enable more complex applications to access lower layer parameters required for a particular configuration. In one embodiment, depending on a particular device configuration, software hooks may be provided to “self configure” the DeviceProperties class. Software instructions or applications could, thus, be received from another device along with a new DeviceProperties class to add desired functionality to a preexisting upper stack 108 to run the received software instructions or application. Based on Service Discovery Protocol (SDP), Java specific services, such as AutoConfig service, could be designed to allow a device to be configured based according to the service attributes delivered via Bluetooth.

Referring to FIG. 5, and any preceding diagrams as needed, an illustration of modules as linked to and within an embodiment of the upper stack is seen. In one embodiment, a Java or Java-like upper stack 108 comprising modules/layers/profiles and other functionality as described herein, facilitates changing and extending the stack functionality without a need for compiling or recompiling the software instructions comprising the upper stack 108. Eliminating a compiling or recompiling step as is typically required in the prior art allows information transmitted from other devices to be dynamically linked to the upper stack 108 to provide the protocol stack 122, application programs 154, software layer 101, the VM, and/or processor 103 new functionality on the fly at run-time or execution. As described herein, eliminating the need for compiling or recompiling the software instructions means that instructions are received and utilized by a receiving host device in the executable binary object form that the instructions existed in on the other device prior to transfer. Information transfer as described herein greatly improves the speed with which the functionality may be executed from and/or by a memory of a receiving device that it is transferred to. In one embodiment, information from other devices may be transferred to memory as jar files comprising compressed information of a form well known by those skilled in the art. In one embodiment, even though the jar files may first need to be decompressed before the functionality comprising the information may be linked and/or utilized by a receiving device's protocol stack or application, the information nevertheless is may be utilized at run-time on the fly without a need to be first compiled or recompiled on the receiving host device. In one embodiment, transferred information may comprise binary information or binary object code. In one embodiment, transferred information may comprise software instruction functionality. In one embodiment, transferred information or additional functionality may comprise updates to software components or portions of or an entirely new upper stack 108. The transferred information or additional functionality may comprise Java or Java-like functionality. Java or Java-like functionality may comprise software instruction functionality, profile functionality, software module functionality, software layer functionality, new API functionality, object code file functionality, software interface functionality to other hardware, class file functionality, class file archive functionality, security manager functionality, file transfer protocol functionality, object exchange protocol (OBEX) functionality, TCP/IP functionality, synchronization profile functionality, object push functionality, dial-up networking profile functionality, LAN access profile functionality, bug fix functionality, patch functionality, new layer functionality, new module functionality, new profile functionality, as well as other functionality, that although not disclosed herein, will be understood to be within the scope of the invention when viewed in light of the claims that follow.

The modular aspects of the upper stack 108 also provides the ability to easily interface the upper stack 108 functionality to other software, for example the functionality of the software layer 101 previously referenced herein.

In one embodiment, the upper stack 108 in its entirety may be uploaded to a receiving device initially lacking the functionality of an upper stack. Such an upload could be facilitated over other wired or wireless communications means, for example, the Internet or cellular airwaves. Once uploaded, the upper stack 108 could then communicate with an application through the upper API 119 and could use a device's communications hardware via a lower API 188 to a device's existing lower stack 105. In one embodiment, the upper stack 108 may be transferred along with other functionality, for example, a Java application, applet, or Midlet. In one embodiment, the upper stack 108 and other functionality, may be transferred from a web site via a web browser application running on the target device.

Non limiting examples of software instructions/modules/layers/profiles that may be dynamically linked to the upper stack 108 include: a security module 181, a device discovery management module 182, a local device management module 183, all defined in the Bluetooth specification. Device discovery management module 182 allows access to inquiry features of the upper stack 108 that may be used to gain knowledge of other devices in range. Local device management module 183 enables access to various properties of local software and hardware.

In a case of an uploaded security module 181, the Bluetooth specification defines a set of authentication procedures. These procedures may be implemented as a Security Interface and a pluggable Security Implementation (not shown). The Security Interface defines generic methods encompassing various known authentication procedures whereas the Security Implementation invokes technology-specific commands to perform authentication. In the case of Bluetooth technology, the commands include Link Key Request and PIN code request. The Security Implementation Module may handle the exchange of Keys or PIN Codes without further interaction by the user. A device initially lacking a security module, could, thus, be provided with such functionality on the fly for dynamic execution by a host device. The functionality could be provided with an application, for example, application written for conducting a financial transaction with another device. The application and security module could be discarded after use to free memory resources.

In one embodiment, the core modules responsible for creating connections and that enable data exchange might not be upgradeable on the fly without disrupting the runtime environment of an application or a processor. To update core modules on the fly with new versions, new core modules could be downloaded and stored locally; and upon a restart/reboot the new core modules could loaded into system memory for initialization.

In one embodiment, the upper stack 108 may further include a lower host controller interface (HCI) 106, an upper HCI 110, a Logical Link Controller and Adaptation Protocol (L2CAP) 112, an API 116, and an implementation of the API 114. In a general sense, API 116 comprises a view that a developer might see of public methods and the like. The upper stack 108 may also include a pluggable host-to-host controller data communications transport interface 107. Transport interface 107 may implement a first serial port 130 and a second serial port 131 with UART circuitry. In one embodiment, the first serial port 130 may be part of an upper device 132, and the second serial port 131 may be part of a lower device 133. In one embodiment, the upper device 132 may comprise a fixed, semi-fixed device, or a portable device. In one embodiment, the lower device 133 may be integral with the upper device 131 or may comprise a separate device.

Interface 107 may be abstracted by upper 110 and lower 106 HCIs as a Java interface defined as HCITransportlnterface through a pluggable transport class. Use of an upper 110 and lower HCIs may be used to implement the hardware of upper 132 and lower 133 separately and thus to allow the upper 108 and lower 105 stacks to reside on physically separate devices. Abstracting the interface 107 with a Java or Java-like class permits the functionality of the upper stack 108 to be easily ported, by wireless or other means, to other devices with Java or Java-like functionality that do not previously have the functionality of the upper stack 108, and so as to enable communication with the other devices lacking such functionality. In one embodiment, if another type of transport interface 107 is desired to be used (i.e., UART, USB type transport, etc.), the upper HCI 108 could be enabled with the desired transport functionality by wireless or other type of download from another device. It is understood that although the lower stack 105 may be programmed part in Java and part in C to provide easy programming access to the functionalities of baseband circuit 104, the lower stack 105 could be programmed in other languages as well.

The abstraction provided by interface 107 facilitates Java or Java-like enabled devices to be enabled with new functionalities on the fly for dynamic execution from memory, despite that a host and target device may operate under different operating systems/platforms/processors. For example, in one embodiment, a Unix-based device could transfer software instructions from a Windows based device and could execute the transferred software instructions dynamically. Thus in the context of previous descriptions herein, in one embodiment, a software application could be transferred between devices and executed rapidly independent of the device platforms, and the software instructions could executed rapidly. For example, software instructions comprising a game application could be transferred from one brand of wireless device to another brand of a wireless device and players on both devices could transfer play information between devices for rapid interactive play with each other.

Referring to Table 1, an exemplary mapping of lower stack 105 commands/packet formats to the API 116 of the Java based upper stack 108 is seen.

TABLE 1

| | |
|---|---|
| Java API | HCI command/event message |
| | (→ toward Baseband hardware) |
| | (← toward Upper Stack) |
| DiscoveryManager.getDevi | Inquiry command → |
| ceList(length_time) | Inquiry result event← |
| | . . . |
| | Inquiry result event ← |
| | Inquiry complete event ← |
| L2CAPStreamConnection. | Create Connection command → |
| open(. . . ) | Connection Request event ← |
| | Accept/Reject Connection Request event ← |
| | Connection Complete event ← |

In one embodiment, the HCI layers 106 and 110 comprise an interface that supports exchange of data packets between the upper 108 and lower 105 stacks. HCI layers 106 and 110 provide an access and communication path to the functionalities of the lower stack 105. The API 116 follows a standard HCI command structure and combines the HCI commands into logical blocks without the need for a developer or user of the upper stack 108 to know any protocol specific features, commands or data packet formats, thereby simplifying the programming task.

Types of data packets supported include: command packets (used to access device hardware capabilities), event notification packets, ACL data packets (used to send/receive data over a link with another device), and SCO data packets (used to send/receive voice data over the link).

In one embodiment, command packets may be used to access functionalities of the lower Bluetooth stack 105. Command packets may be grouped into functional categories that include: (1) Link Control commands used to communicate with the remote device are used to request an inquiry (i.e., a process of discovering other active devices in accessible range), to setup connections, for authentication, and remote device information; (2) Link Policy commands used to manage the state of a piconet (a logical and physical network of Bluetooth devices with 1 master device and up to 7 active slave devices) and its members; (3) HCI and baseband circuit commands used to access device properties; (4) Informational commands used to read device features; (5) Status commands used as physical link status commands; (6) Test commands used as test mode commands; (7) Vendor specific commands that are defined by vendors of Bluetooth hardware.

The commands from the upper HCI 110 may be passed to the lower HCI 106 in a synchronous fashion. Each command may be followed by CommandComplete event, or CommandStatus event if it involves a message exchange with other devices. The lower stack 105 may respond to each of the upper stack 108 commands with one of these 2 events within a specified time (Bluetooth specifications suggest 1 second timeout to accommodate various transports and hardware implementations). Remote events resulting from messages or data arriving from remote devices may be passed to the upper stack 108 using an asynchronous notification mechanism. HCI layers 106/110 preferably support all commands and events of the Bluetooth specification. All CommandComplete and CommandStatus events are returned to the originator of the command and remote events are sent to their registered receivers.

Referring now to FIG. 6 and any preceding diagrams as needed, an embodiment of a single host configuration is seen. The FIG. 6 embodiment is similar to the FIG. 4 embodiment, except that both the upper 128 and lower 125 stacks may reside in a memory space of one device 144, for example, in a SRAM of a fixed or portable device like a wireless device or PDA. A single host configuration is disclosed in commonly assigned U.S. Provisional Applications Ser. No. 60/208,967, 60/220,047, 60/239,320, 60/267,555, and 60/271,607, which are listed as Related Applications As described in these applications, once information is transferred to locations in memory of a wireless device, various software/modules/layers/profiles may perform operations on the information without a need for copying the information to other locations.

The embodiment of FIG. 6 may be partitioned in a variety of ways with respect to software and hardware implementations of each functional block. HCI messages relayed from the upper stack 128 may be passed directly onto the lower stack 125 using well defined notification mechanisms and memory buffers. In this embodiment, the upper and lower HCI layers may be designed as a single “thin” interface used to properly format control messages and data packets and control the flow of command/event packets between the upper 128 and lower 125 stacks.

In one embodiment, the API may be used with the HCI and L2CAP layers to provide a number of methods that allow devices to gain knowledge of other devices within its range, as well as to establish connections between the devices. The following functionality may be implemented with the API, L2CAP, and HCI layers: (1) initializing HCI communication transport between Bluetooth enabled devices; (2) notifying about active devices responding to an inquiry process and devices that are no longer responding to the inquiry process; (3) opening/closing a connection between devices.

In both the embodiments of FIGS. 4 and 6, L2CAP 112/122 manages logical channels established between devices, and adapts software communications protocols that describe known sequences of messages (for example, Service Discovery Protocol, and RFCOMM protocols) defined by software layers above L2CAP that comply with the Bluetooth specification. Logical channels are connection pipes established within an existing Asynchronous Connectionless Link (ACL) link. L2CAP 112/122 identifies each channel with a ChannelID, and every ACL connection with a connection handle. These values are transmitted with every data packet to uniquely identify the destination protocol. Control and data packets sent by upper stack protocols RFCOMM and SDP are segmented by the L2CAP 112/122 into HCI/baseband data packets and sent to other devices. Similarly, packets arriving from other devices and destined for any upper protocol are reassembled by L2CAP 112/122 to match the format expected by receiving protocol. The upper protocols are addresses that use a Protocol Service Multiplexer (PSM) number. All standard protocols such as SDP (Service Discovery Protocol) and RFCOMM (serial communication emulator) have predefined PSM numbers. Any other PSM number for a custom protocol can be obtained from services database using SDP messages.

PSM value is based on the ISO/IEC 3309: 1993 extension mechanism (hereby incorporated by reference) for address fields. All PSM values are odd. PSM values are separated into two ranges. Values in the first range are assigned by a Bluetooth SIG and indicate protocols. The second range of values are dynamically allocated and used in conjunction with SDP. The dynamically assigned values may be used to support multiple implementations of a particular protocol; for example, RFCOMM, residing on top of L2CAP 112/122 or for prototyping an experimental protocol. PSM values include ranges: 0×1000—SDP; 0×0003—RFCOMM; 0×0005—Telephony Control Protocol; <0×1000—Reserved; 0×1001: 0×FFFF—Dynamically assigned.

Referring briefly back to FIG. 4, to set up the serial port to which a lower device 133 is connected, as well as to setup the lower device, a defined BtStack class provides an initializeStack method. By writing the upper stack 108 using a Java or Java-like programming language, vendor specific commands written in Java or a Java-like programming language may be added to the stack on an as needed basis. An example of a vendor specific command is SetBaudRate, which can be used to change the speed of the UART serial port 131 of the lower device 133.

InitializeStack method may be used at the beginning of any Bluetooth session, for example, where a loaded and operational stack is used to set up connections with other devices, close the connections, discover other devices and all activities related to the stack while it is loaded and running. InitializeStack method opens a communications port (serial, USB, etc.) in the interface 107 and provides a convenient way of instantiating all required layers of the upper 108 and lower 105 stacks. In the FIG. 6 embodiment, with the upper stack 128 running with the lower stack 125 in one memory space, initialization may be done at power-on time such that initializeStack need not be called. To initialize the stack, an instance of transport driver that implements a communications interface is used. In one embodiment, the communications interface is called CommInterface. The CommInterface transport driver may provide means for accessing a physical port on a given platform to communicate with the lower stack. In one embodiment, the Commlnerface API is a platform independent with each transport driver implementing CommInterface being platform or communications port specific.

If the initializeStack method is used with J2SE, two parameters are used: serial port name and baud rate. The baud rate should be the same as the one the data UART port in transport mechanism 107 is set to. When initializing upper 108 and lower stacks 105 in J2ME, there is no need to provide parameters, because in the programming environment the parameters port and baud rate are given as command line switches and are handled internally, for example, as illustrated by the following code segments:

```
  / / J2SE based stack initialization
  import com.zucotto.net.bt.BtStack
  . . . . .
BtStackUart stack = new BtStackUart(port, baud);
    stack. intializeStack()
  ;
/ / J2ME based stack initialization
import com.zucotto.net.bt.BtStack
  . . . . .
BtStackCLDCUart stack = BtStackCLDCUart.getInstance(port, baud);
    stack. intializeStack();
  ;
```

The initiliazeStack() method may also be used to set up the baseband circuit 104. The following actions are performed by the baseband circuit 104 and lower stack 105: (1) scanning capability is enabled so hardware will be put periodically into Inquiry_Scan (local device will go into Inquiry_Scan mode for 11.25 ms, every 1.28 sec) and Page_Scan (Page_Scan mode values are the same as Inquiry_Scan mode) modes to listen for incoming inquiry requests or connection requests from remote devices; (2) connection accept timeout is set to 29 seconds (maximum allowable); (3) page timeout (paging is a process of setting up a connection between two devices) is set to 40.1 seconds. Authentication for ACL links and connection acceptance criteria may be handled by Security Manager. With the above described method, software and hardware may be initialized and a connection may be established with another device.

Referring now to FIG. 7 and any preceding diagrams as needed, there is seen a graphical representation of a periodic inquiry process and DiscoveryListener notification mechanism. In one embodiment, the upper stack 108 includes shared information and resources as well as specific connection resources and data owned only by one client (an application using stack resources to communicate with another device). Shared knowledge of other devices within a devices range may be acquired by implementing the ability to discover the addresses of these other devices using an inquiry process defined in the Bluetooth specification. In one embodiment, the inquiry process is implemented via an interface DiscoveryListener and DiscoveryManager class, wherein a periodic inquiry mode is invoked as soon as there is at least one client (application) that needs to know about results received from an HCI command. The results are distributed to any number of registered listeners, which allows clients to stack (applications) on the same local device to receive information at the same time. The unique implementation of the upper stack 108 allows clients to the stack (applications) on the same local device to use the same instantiation of the stack. Multiple client applications may be notified of “publicly available events,” for example, of the presence of active devices in the neighborhood. Upon establishing a connection, an application that owns this connection is the only one that sees data for this connection.

Referring to FIG. 8 and any preceding diagrams as needed, there is seen a graphical representation of a call to the getDeviceList method. DiscoveryListener defines 2 callback methods: deviceFound and deviceLost. DiscoveryManager class provides a registration method for these events as well as a method getDeviceList that returns an array of device addresses. DiscoveryListener is an interface that allows for the reception of events representing changes occurring in a list of discovered devices originating from DiscoveryManager.

DicoveryManager includes the ability to periodically invoke a Bluetooth inquiry process, maintain a list of discovered active devices, and notify any Java application (or a particular part of it implementing the interface) of any changes resulting from the invoked inquiry process.

The following is a programming example that illustrates the aforementioned interfaces:

Public class DiscoveryManager

```
{
  / / initiate the periodic inquiry process by sending a command to
  / / the bluetooth hardware.
  / / The lower level code required to communicate with bluetooth
  / / hardware is omitted
  public void addDiscoveryListener(DiscoveryListener 1)
  {
  / / register a Java object to be a listener to
  / / the changes resulting from the inquiry process
  this.Listener = 1;
  }
  public String[] getDeviceList()
  {
  / / return a list of active device addresses
  }
  public void inquiryResult(InquiryResults insRes)
  {
  / / notification coming from the bluetooth
  / / hardware with the results of inquiry process
  / / at this point, a user can choose to notify any registered
  / / listener of the discovery of a device
  this.Listener.deviceFound(deviceID)
  }
  public void inquiryComplete(InquiryCompleteResults incCompRes)
  {
  / / notification coming from the bluetooth
  / / hardware with the results of inquiry process
  / / at this point, a user can choose to notify any registered
  / / listener of the any devices lost or discovered during the inquiry
  process this.Listener.deviceLost(deviceID);
  }
}
```

In one embodiment, DiscoveryManager may invoke an inquiry process in two different ways, one time inquiry and periodic inquiry. One time inquiry is invoked whenever getDeviceList method is called. It completes only after the inquiry process completes (the length of the one time inquiry process is determined to optimally be 6.4 seconds, but other times may be used) and returns an array of strings representing other devices. If there are any listeners registered to receive deviceFound/Lost events, getDeviceList method stops periodic inquiry, performs the single inquiry, then resumes the periodic inquiry process, returning with the array of device addresses found in the single inquiry process.

Periodic inquiry process is a one time inquiry repeatedly executed with specified intervals (the interval between two consecutive inquiries is determined to optimally be ˜30 seconds, but other times may be used as specified by the application using the protocol stack). This process begins as soon as there is at least 1 registered listener of deviceFound/Lost events. As other devices respond to the inquiry requests, the listener is notified using deviceFound event. If a previously discovered device does not respond during two consecutive inquiry processes, it is considered lost and deviceFound event is fired to the listener.

Referring now to FIG. 9 and any preceding diagrams as needed, a state diagram of an implementation of DiscoveryManager is seen. DiscoveryManager may be used to allow applications to discover other active devices within its range. Because communication occurs through a series of commands which enable or disable the inquiry process, when inquiry mode is invoked, the ability to perform other functions may be limited. One mechanism for addressing these limitations is described next.

DiscoveryManager may be used to define three methods to achieve notification of the status of currently active devices. Any application implementing DiscoveryListener may register itself as a listener for any changes in the neighborhood of the wireless device. Upon registration of the first listener, DiscoveryManager invokes periodic inquiry mode through a series of commands. DiscoveryManager may use parameters defined through setlnquireyPeriod (int interval, int duration) to set a device to perform an inquiry at a set period for a set interval. To save the resources, upon deregistration of the last DiscoveryListener, DiscoveryManager may command to cease periodic inquiry mode.

The DiscoveryManager, through the DiscoveryManager allows applications to save on-board resources by offering the ability to perform a single inquiry process through method getDeviceList(searchlength).

To be discovered in an inquiry, other devices should also be in an inquiry scan mode. The discovery of other devices may also suffer from instability in the inquiry process due to the devices being in different modes of activity or being on the edge of the wireless transmission range where they may briefly leave and re-enter range. To stabilize the reporting of found devices each previously discovered device is not be considered lost until the discovery process has been performed a certain number of times and the devices have not been found for each of the consecutive discovery processes.

This concept of device list “stickiness” is implemented in one embodiment by setting the number of consecutive discovery processes to N. Where N is determined by dividing the latency (amount of time a device can be considered to be still connected) by the inquiry process interval (the time between the start of one inquiry to the start of the next). In the embodiment both the latency and inquiry process interval are settable by the application using the protocol stack with the default values set to a latency of 30 seconds and inquiry process interval set to 30 seconds and hence the stickiness factor of 1. The device list stickiness shields the applications using the protocol stack from having to respond to false or redundant device status changes and frees up more processing time for other tasks.

The following are code samples using the above-described processes:

```
//one time inquiry
  import com.zucotto.net.bt.gap.DiscoveryManager
  public class myApp
  {
    BtStackUart stack = new BtStackUart(port, baud);
    stack.intializeStack();
    DiscoveryManager discovery =
    (DiscoveryManager)stack.getLayer(stack,
        LAYER_DISCOVERY_MANAGER, null);
    / / search for devices for 10 seconds
    String[] devices = discovery.getDeviceList(10);
    for(int I = 0; I < devices.length; I++)
    {
      System.out.println(“device found” + devices[I]);
    }
  }
```

If three devices respond to an inquiry process, this code may produce the following output:

device found: CAFEBABE0001

device found: CAFEBABE0002

device found: CAFEBABE0003

CAFEBABE000x is a Bluetooth address of a device.

```
/ / periodic inquiry
  import com.zucotto.net.bt.*;
  public class MyApp extends DiscoveryListener
  {
    BtStackUart stack = new BtStackUart(port, baud);
    stack.intializeStack();
    DiscoveryManager discovery =
    (DiscoveryManager)stack.getLayer(stack,
        LAYER_DISCOVERY_MANAGER, null);
/ / set the inquiry to occur every 10 seconds for 5 seconds
discovery. setInquiryPeriod(10, 5)
discovery.addDiscoveryListener(this)
. . .
```

To open a stream-type connection between two devices, a device address may be used. In order for a successful connection to be established, the non-initiating device (server type devices waiting for incoming connections) may be in Page_Scan mode and not in the Inquiry or Inquiry_Scan process. This behavior may be caused by different hopping frequency sequences used for these modes. Also automatic switching from one mode to another must be explicitly supported by hardware. In one embodiment, baseband circuit 104 may not support automatic switching. Due to this limitation, all inquiry processes may need to be stopped on both devices in order to get a successful connection. To return to inquiry processes, existing connections may need to be closed. Such a condition may be caused by lack of hardware and lower stack support for Hold_Mode (temporary suspension of an existing ACL connection). In order to perform an inquiry, all existing ACL connections may be put into Hold_Mode, then an inquiry can be performed. Once an inquiry is complete, connections may be taken off Hold_Mode and put back into active mode.

API 116/126 provides two ways of establishing a Bluetooth connection: server mode, in which a device acts as a server; and waiting for incoming connection requests or client mode, in which a device is the connection initiator.

```
/ / J2SE server mode connection setup
import com.zucotto.bt.L2CAPStreamConnection;
import java.io.*;
public class MyApp
{
  L2CAPStreamConnection conn;
  InputStream is;
  OutputStream os,
  . . .
  try
  {
  conn = new L2CAPStreamConnection();
  conn.acceptAndOpen(null,0X1001)
is = conn.openInputStream();
  os = conn.openOutputStream();
}
  catch (Exception e)
  / / connection failed
  {_}
  . . .
}
/ / J2SE client mode connection setup
import com.zucotto.bt.L2CAPStreamConnection
public class MyApp
{
  L2CAPStreamConnnection conn;
  InputStream is;
  OutputStream os;
  . . .
  try
  {
  conn = new L2CAPStreamConnectioion();
  conn.open(“CAFEBAEE0000”,0x1001)
  is = conn.openInputStream();
  os = conn.openOutputStream();
}
  catch (Exception e)
  {_}
  . . .
}
```

In server mode, method acceptAndOpen is used with 2 parameters. The first parameter comprises an address. The value of this parameter should be null to accept connections from any device or should specify an address to accept connections from a specific device. The second parameter is the PSM number. Although, both devices, server and client, trying to connect to each other, typically use the same PSM number, a client only need know the PSM number of what it is trying to connect to.

```
  / / J2ME server mode connection setup
  import com.sun.cldc.io.j2me.bluetooth.*;
  import java.io. *;
  . . .
  public class MyApp
  {StreamConnection conn;
  . . .
  connection (StreamConnection) Connector.open
  (“bluetooth:/ / psm=1001”);
  OutputStream out = connection.openOutputStream();
  InputStream in = connection.openInputStream();
  / / Client mode connection setup
  StreamConnection connection;
  connection = (StreamConnection) Connector.open(“bluetooth:/ /
        cafebabe0000;psm=1001”);
  OutputStream out = connection.openOutputStream();
  InputStream in = connection.openInputStream();
  / / cafebabe0000 is the remote device Bluetooth address
  / / psm is the local protocol/application identifier, use odd values / / in
the 0x1001 − 0xFFFF
  / / to close existing connection use:
  connection.close ();
```

In addition to the basic InputStream and OutputStream I/O streams, DatalnputStream and DataOutputStream methods are also provided.

Referring briefly back to FIG. 4 and other diagrams as needed, the embodiment of FIG. 4 may be viewed as comprising four functional parts, which for the purposes of the following discussion are referred to as parts 1-4, wherein part 1 includes the baseband circuit 104, RF module 102, an antenna, lower stack 105, and lower HCI 106; wherein part 2 includes upper HCI 110 and L2CAP 112, wherein part 3 includes upper stack protocols RFCOMM and SDP (not shown, but described previously), as well as other basic protocols such as GAP, SDAP, and SDP; and wherein part 4 includes API 116 and implementation 114 profiles. Generally speaking, part 1 may include hardware components and physical link management software, which an upper device 132 would need access to. Part 2 may include logical protocol management required for a minimum level of interoperability with other devices. Part 3 may include more advanced protocols that may or may not be necessary in a particular implementation. Part 4 may include Bluetooth API and implementation profiles. Profiles may combine sets of functional requirements and applicable implementations to add specific functionality. Profiles may be written in Java or a Java-like language. An example of a profile may be a printing profile, which allows a first Bluetooth enabled device comprising the functionality of parts 1-4 to access a second Bluetooth enabled device over the airwaves, for example, a printer, which could then be used to print documents stored on the first Bluetooth enabled device.

Referring now to FIG. 10 and any preceding diagrams as needed, a flow diagram for usage of a printer profile is seen. In one usage scenario, a user of a first device (for example, a phone, PDA, etc.) may choose to use a printer comprising Bluetooth wireless capabilities to print a web page information and graphics stored on a first device (block 171). Preferably, when the user approaches the printer, the first device will find a printing service available in range (block 172), for example, via SDP records. One of the requirements for use of the printer by the first device may be that the first device include an appropriate print profile. After gathering required print service information (block 173), if it is determined that the first device does not have a print profile installed (block 174), the printer could be used to send the appropriate profile to the first device (block 175), for example, as Java classes. If the printer does not have the ability to transfer the required profile or have the profile stored, the first device could acquire the profile classes using other wireless capabilities, for example, regular commercial wireless carrier network or wireless LAN network (block 179). In addition, a service discovery process such as the Jini framework from Sun Microsystems could be used to find and download the required information. In order to print color pages (block 176), another attribute of the printer could communicate to the first device that a special printer driver would be required to format the data correctly. Again, the printer could deliver the required driver to the first device via the Bluetooth connection (block 180), otherwise the first device could download the driver using wireless carrier network or other network means. After the profile and driver are downloaded and linked to the protocol stack of the first device, the user could print pages formatted fully for the particular type of printer from the first device (block 177). After printing, the print profile and/or the driver could be removed from the first device if memory resources were of concern, as they often are in handheld battery operated wireless devices (block 178). It should be noted that any one of the parts 2, 3, or 4 described in FIG. 4 could also be dynamically transferred to the first device over a network (including the Bluetooth wireless network itself and used to update the first device's functionality.

Referring to FIG. 11, and any preceding diagrams as needed, an embodiment with two or more protocol stacks is seen. In one embodiment, two or more protocol stacks 122 may be implemented in host and/or target devices. A representation of two such protocol stacks is illustrated as 122a and 122b. In devices comprising two or more protocol stacks, two or more antennas, baseband circuits 104a and 104b, and two or more RF modules corresponding to respective protocol stacks may also be provided. The circuitry for two or more baseband embodiments is understood to be within the scope of those skilled in the art. Although not shown in FIG. 11, it is understood that each of the two or more protocol stacks may communicate with the support layer 101, application programs 154, and baseband circuits through respective separate API's. With two ore more protocol stacks as described herein, it is understood that each protocol stack could comprise instances of the same software components. With two or more protocol stacks, the available bandwidth of a device hosting the protocol stacks may be increased. Furthermore, memory requirements may be reduced because multiple instantiations may use the same class code. In one embodiment, the two or more protocol stacks could be used to exchange and execute respective individual streams of information transferred by a receiving host device from two or more sources of the information, for example, one stream of information could be a video based application received from one device, another stream of information could be audio based application information from a second device. In accordance with the information disclosed previously herein, each protocol stack could be used to dynamically execute the information, regardless of the systems/platforms/processors of the devices.

Although the embodiments described herein are with reference to specific embodiments', it is understood that with appropriate modifications and alterations, the scope of the present invention encompasses embodiments that utilize other features and elements, including, but not limited to other Java-like languages, environments and software instructions similar in functionality to that described herein, for example, Common Language Interchange (CLI), Intermediate Language (IL) and Common Language Run-time (CLR) environments and C# programming language as part of the .NET and .NET compact framework, available from Microsoft Corporation Redmond, Wash.; Binary Run-time Environment for Wireless (BREW) from Qualcomm Inc., San Diego; or the MicrochaiVM environment from Hewlett-Packard Corporation, Palo Alto, Calif., and other wireless communications protocols and circuits, for example, TDMA, HDR, and DECT, iDEN, iMode, GSM, GPRS, EDGE, UMTS, CDMA, TDMA, WCDMA, CDMAone, CDMA2000, IS-95B, UWC-136, IMT-2000, IEEE 802.11, IEEE 802.15, WiFi, IrDA, HomeRF, 3GPP, and 3GPP2, and other wired communications protocols, for example, Ethernet, HomePNA, serial, USB, parallel, Firewire, and SCSI, all well known by those skilled in the art.

Furthermore, the operating systems/platforms/processors described herein are also not meant to be limiting, as other operating systems/platforms/processors are contemplated for use on or with host and/or target devices, for example, Unix-based, Macintosh OS, Linux, DOS, PalmOS, and Real Time Operating Systems (RTOS) available from manufacturers such as Acorn, Chorus, GeoWorks, Lucent Technologies, Microwave, QNX, and WindRiver Systems. Furthermore, the target and host devices described herein are also not meant to be limiting to the invention as other embodiments contemplate that they may comprise wireless basestation, network access point, gaming device, music player/recorder, remote control, industrial automation control device, personal organizer, wireless audio device, and sensor interface devices. The present invention should, thus, not be limited by the description contained herein, but only by the claims that follow.

What is claimed is:

1. A method of modifying a wireless protocol stack on a first device, the protocol stack comprising a plurality of protocol layers, the protocol layers comprising one or more existing software components, the method comprising the steps of:
providing the protocol stack in a run-time system on the first device;
downloading at least one updated software component to the first device;
loading the at least one software component into the run-time system; and
replacing one or more of the exiting software components with the at least one updated software component to update the protocol stack on the fly while the protocol stack is running in run-time.

2. The method of claim 1, wherein the existing software components and the at least one updated software components comprise platform independent software instructions.

3. The method of claim 2, wherein the platform independent software instructions comprise Java™ software instructions.

4. The method of claim 1, wherein the at least one updated software component comprises an update to at least one of the protocol layers.

5. The method of claim 4, wherein the at least one updated software component comprises an update to all the protocol layers.

6. A wireless device, comprising:
a baseband circuit, the baseband circuit receiving functionality as transmitted in object form by a second device; and
a platform independent protocol stack, the platform independent protocol stack transferring the functionality from the baseband circuit to the wireless device such that the wireless device may utilize the functionality on the fly during run-time and in the object form transmitted by the second device.

7. A first device operating with a first operating environment, the first device comprising:
a memory;
a protocol stack, the protocol stack residing in the memory, the protocol stack comprising executable Java-like functionality, the executable Java-like functionality modifiable on the fly; and
execution means for executing the executable Java-like functionality.

8. The first device of claim 7, the first device further comprising a baseband circuit, the baseband circuit receiving the executable Java-like functionality and providing the executable Java-like functionality to the protocol stack.

9. The first device of claim 7, the executable Java-like functionality selected from a group consisting of software instruction, software module, software layer, API, object code file, software interface to hardware, class file, class file archive, security manager, file transfer protocol, object exchange protocol (OBEX), TCP/IP stack, synchronization profile, object push profile, dial-up networking profile, bug fix, code patch, and LAN access profile functionality.

10. The first device of claim 8, the executable Java-like functionality received from a second device operating under a second operating environment, the second operating environment differing from the first operating environment.

11. The first device of claim 7, the protocol stack comprising a Bluetooth™ compatible protocol stack.

12. The first device of claim 7, the first device comprising a cellular phone.

13. The first device of claim 7, the first device selected from a group consisting of: a personal digital assistant, wireless basestation, network access point, gaming device, music player/recorder, remote control, industrial automation control device, personal organizer, wireless audio device, and sensor interface.

14. The first device of claim 7, the execution means executing the executable Java-like functionality as micro-instructions.

15. The first device of claim 8, the baseband circuit comprising a Bluetooth™ baseband circuit.

16. The first device of claim 10, the first operating environment comprising a virtual machine, and the second operating environment selected from the group consisting of a Windows operating environment, a Unix-based operating environment, a Macintosh operating environment, a Linux operating environment, a DOS operating environment, a PalmOS operating environment, a virtual machine environment, and a Real Time Operating System operating environment.

17. The first device of claim 10, the first operating environment comprising a Windows operating environment, and the second operating environment selected from the group consisting of a Unix-based operating environment, a Macintosh operating environment, a Linux operating environment, a DOS operating environment, a PalmOS operating environment, virtual machine and support software operating environment, and a Real Time Operating System operating environment.

18. A first device operating under a first operating environment, the first device comprising:
means for transferring a protocol stack to the first device from a second device operating under a second operating environment; and
a baseband circuit, the baseband circuit interacting with the protocol stack to transfer information between the first device and the second device.

19. The device of claim 18, the first operating environment differing from the second operating environment.

20. A first device operating under a first operating environment for communicating with a second device operating under a second operating environment, the first device comprising:
means for transferring software instructions from the second device to the first device; and
means for executing the software instructions dynamically at run-time.

21. The first device of claim 20, the means for transferring comprising a communications protocol stack.

22. The first device of claim 21, the means for executing the software instructions comprising an application layer program.

23. The first device of claim 22, the protocol stack comprising semi-compiled/interpreted instructions.

24. The first device of claim 22, the software instructions comprising byte-codes.

25. The first device of claim 24, the first operating environment differing from the second operating environment.

26. The first device of claim 25, the first operating environment comprising a virtual machine and software support layer, and the software instructions originating from a second operating environment selected from the group consisting of: a Windows operating environment, a Unix operating environment, a Macintosh operating environment, a Linux operating environment, a DOS operating environment, a PalmOS operating environment, and a Real Time Operating System operating environment.

27. The first device of claim 21, the first device comprising a wireless device.

28. The first device of claim 27, the software instructions comprising Java™ byte-codes.

29. The first device of claim 20, the software instructions comprising a protocol stack.

30. A method of communicating between a first wireless device operating under a first operating environment and a second wireless device operating under a second operating environment, comprising the steps of:
downloading platform independent software instructions in executable form from the second device to the first device; and
executing the instructions on the fly.

31. The method of claim 30, the software instructions comprising a protocol stack.

32. The method of claim 30, the step of downloading software instructions comprising downloading over a wireless medium.

33. The method of claim 32, the software instructions comprising Java-like software instructions.

34. The method of claim 31, the protocol stack comprising a platform independent protocol stack.

35. The method of claim 33, the first operating environment differing from the second operating environment.

36. A wireless device operating with a first operating environment for communicating with other devices operating with a second operating environment, comprising:
a storage location;
means for downloading functionality existing on the other devices to the storage location;
a processor; and
an application program, the application program running on the processor; the application program utilizing the functionality on the fly at run-time.

37. The wireless device of claim 36, the functionality comprising a protocol stack.

38. The wireless device of claim 36, the functionality comprising two or more protocol stacks.

39. The wireless device of claim 36, the means for downloading comprising a communications protocol selected from the group consisting of: Bluetooth™, GSM, 802.11, 802.11b, 802.15, WiFi, IrDA, HomeRF, 3GPP, 3GPP2, CDMA, HDR, and TDMA, UMTS, GPRS, I-mode, IMT-2000, iDEN, Edge, Ethernet, HomePNA, serial, USB, parallel, Firewire, and SCSI protocols.

40. The wireless device of claim 37, further comprising a baseband circuit, the baseband circuit communicating with the other devices in cooperation with the protocol stack.

41. The wireless device of claim 40, the means for downloading functionality comprising a cellular phone communications protocol, the protocol stack downloaded utilizing the cellular phone communications protocol.

42. The wireless device of claim 41, the cellular phone communications protocol selected from a group consisting of TDMA, CDMA, GPRS, GSM, EDGE, UMTS, I-mode, IMT-2000, iDEN, and 3GPP protocols.

43. The wireless device of claim 36, the means for downloading functionality comprising a communications protocol selected from a group consisting of Bluetooth™, IEEE 802.11, 802.11b WiFi, IEEE 802.15, IrDA, and HomeRF protocols.

44. The wireless device of claim 36, the functionality selected from a group consisting of Java™ byte-code, Java-like software instruction, profile, software module, software layer, API, object code file, class file, class file archive, application data, bug fix, patch, and software interface to hardware functionality.

45. The wireless device of claim 36, the first operating environment comprising a virtual machine, and the functionality originating from a second operating environment selected from the group consisting of: a Windows operating environment, a Unix operating environment, a Macintosh operating environment, a Linux operating environment, a DOS operating environment, a PalmOS operating environment, a virtual machine operating environment, and a Real Time Operating System operating environment.

46. A wireless device operating under a first operating environment, comprising:
a processor;
a baseband circuit, the baseband circuit receiving software instructions stored in object form on a second device; and
a platform independent protocol stack for transferring software instructions from the baseband to an application program running on the processor, the application program executing the software instructions in the object form stored on the second device without compilation of the software instructions.

47. A computer readable medium comprising instructions for transferring executable functionality from a baseband circuit, including instructions for:
converting the executable functionality according to a communications protocol; and
providing the converted executable functionality directly to at least one application program at run-time.

48. The medium of claim 47, the executable functionality selected from a group consisting of Java™ byte-code, Java-like software instruction, profile, software module, software layer, API, object code file, class file, class file archive, application data, bug fix, patch, and software interface to hardware functionality.

49. The medium of claim 47, the at least one application program comprising at least one platform independent protocol stack.

50. The medium of claim 49, the at least one platform independent protocol stack comprising at least two separate platform independent Java™ based protocol stacks.

51. The medium of claim 47, wherein the executable functionality is received by the baseband circuit in object form, and wherein the converted executable functionality is provided to the at least one application program without compiling the executable functionality.

52. A storage device operatively coupled to a processor and a Bluetooth™ baseband, comprising: a platform independent Bluetooth™ protocol stack, the Bluetooth™ protocol stack for operating on Bluetooth™ packets, the packets being transferred between an application executing on the processor and the Bluetooth™ baseband, the protocol stack comprising Java-like software instructions.

53. A wireless device comprising:
a processor;
means for storing information;
a baseband circuit, the baseband circuit for transmitting and receiving the information; and
a wireless protocol stack for transferring the information between the baseband and an application program executing on the processor, the protocol stack residing in or on the means for storing information, the protocol stack comprising Java™ software instructions.

54. A device comprising:
a processor;
means for storing information;
a communication circuit, the communication circuit transmitting and receiving the information as binary information; and
a platform-independent communication protocol stack, the platform-independent communication protocol stack transferring the binary information between the communication circuit and an application program executing on the processor, the protocol stack residing in or on the means for storing information, the protocol stack comprising a plurality of executable software layers, each layer providing differing functionality, wherein one or more of the layers are dynamically configurable on the fly at run-time.

55. The device of claim 54, wherein the communication circuit comprises a baseband.

56. The device of claim 55, wherein the baseband is selected from the group comprising: Bluetooth, IEEE 802.11, 802.11b, WiFi, GSM, IEEE 802.15, IrDA, 3GPP, 3GPP2, CDMA, HDR, UMTS, GPRS, I-Mode, IMT-2000, iDEN, EDGE, or TDMA basebands.

57. The device of claim 54, wherein the communication circuit is selected from the group comprising: Ethernet, HomePNA, HomePlug, serial, USB, parallel, Firewire, and SCSI communication circuits.

58. A method of modifying existing protocol layers of an existing protocol stack, the protocol layers comprising one or more existing software components, the method comprising the steps of:
loading a protocol stack into a run-time environment;
downloading at least one new software component;
loading the at least one new software component into the run-time environment, wherein the at least one new software component interacts with the existing protocol layers so as to provide additional functionality to the existing protocol at run-time.

59. The method of claim 58 wherein the existing software components and the new software components comprise platform independent software instructions.

60. The method of claim 59 wherein the platform independent software instructions comprise Java™ or Java-like software instructions.

61. The method of claim 58 wherein the additional functionality is selected from the group of functionality comprising: software instructions, software profile, software module, software layer, API, object code file, software interface to hardware, class file, class file archive, security manager, file transfer protocol, object exchange protocol (OBEX), TCP/IP stack, synchronization profile, object push profile, dial-up networking profile, bug fix, patch, and LAN access profile functionality.

62. A device comprising:
a processor;
means for storing software components;
at least one application program executing on the processor;
at least two communication circuits, the communication circuits transmitting and receiving binary information; and
at least two platform-independent communication protocol stacks for transferring software instructions between the at least two communication circuits and the at least one application program executing on the processor, the at least two platform independent protocol stacks comprising software components stored on the means for storing, wherein each of the at least two platform-independent communication protocol stacks comprise instances of the same software components.

63. The device of claim 62 wherein the software components comprise one or more Classes.

64. The device of claim 63 wherein the Classes comprise Java™ or Java-like software instructions.

65. The device of claim 62 wherein the communications circuits are selected from the group comprising: Bluetooth, IEEE 802.11, GSM, IEEE 802.15, IrDA, 3GPP, 3GPP2, CDMA, or TDMA basebands.

66. The device of claim 62, wherein the communication circuits are selected from the group comprising: Ethernet, HomePNA, serial, USB, parallel, Firewire, and SCSI communication circuits.

67. The device of claim 62, wherein the communications circuits comprise a first and a second baseband, wherein the binary information comprises a multimedia stream, the first baseband receiving a first portion of the multimedia stream, the second baseband receiving as a second portion of the multimedia stream.

68. The device of claim 67, wherein the first portion comprises video information and wherein the second portion comprises audio information.
